(19) United States
(12) Patent Application Publication
(10) Pub. No.: US 2015/0365475 A1
(43) Pub. Date: Dec. 17, 2015

(54) Resource Allocation Method and Device for Direct Communication Between User Devices

(71) Applicant: Huawei Device Co., Ltd., Shenzhen (CN)

(72) Inventor: Jian Wang, Beijing (CN)

(21) Appl. No.: 14/834,705

(22) Filed: Aug. 25, 2015

Related U.S. Application Data
(63) Continuation of application No. PCT/CN2014/081713, filed on Jul. 7, 2014.

(30) Foreign Application Priority Data
Jul. 8, 2013 (CN) 201310284528.1

(51) Int. Cl. H04L 29/08; H04L 12/911

(52) U.S. Cl. CPC H04L 67/1078; H04L 47/828

(57) ABSTRACT

A resource allocation method and a device for direct communication between user devices are provided. The method includes determining, by a third device, a first resource, where the first resource includes some or all of a second resource, the second resource is determined by the third device before the first resource is determined, and the first resource and the second resource are both used for communication between a first user device and a second user device, and sending, by the third device, resource signaling to the first user device and/or the second user device, where the resource signaling carries information about the first resource. When a resource for direct communication changes, a normal direct communication service of user devices is ensured.

### CROSS-REFERENCE TO RELATED APPLICATIONS

This application is a continuation of International Application No. PCT/CN2014/081713, filed on Jul. 7, 2014, which claims priority to Chinese Patent Application No. 201310284528.1, filed on Jul. 8, 2013, both of which are hereby incorporated by reference in their entireties.

### TECHNICAL FIELD

The present disclosure relates to the field of mobile communications technologies, and in particular, to a resource allocation method and device for direct communication between user devices.

### BACKGROUND

A device to device proximity service (D2D ProSe) has become a research subject of the 3rd Generation Partnership Project (3GPP) in a Long Term Evolution (LTE) Re1.12 system, and begins to be supported from the Re1.12 system. Direct communication between user devices includes a signal discovery process and a direct communication process. The signal discovery process includes sending of a discovery signal and receiving of the discovery signal. The direct communication process includes a series of processes such as call initiation, channel measurement, channel feedback, resource scheduling, data transmission, and call completion.

In a scenario in which a user device communicates with a base station, the user device measures channel quality and feeds back the channel quality to the base station, and the base station performs resource scheduling for the user device according to the channel quality fed back by the user device. When delivering resource scheduling signaling, the base station may further send a parameter required for data communication on a scheduled physical resource to the user device. In this way, after receiving the scheduling signaling, the user device can perform data communication on the scheduled resource.

However, in a scenario of direct communication between user devices, a base station cannot learn information about a state of a channel between the user devices, and therefore cannot learn a parameter required for direct communication between the user devices. The user devices need to send a channel sounding signal to obtain the channel state information, to determine the parameter required for data communication. Therefore, when a resource for direct communication changes, communication currently performed between the user devices needs to be interrupted, to perform channel sounding to obtain the parameter required for data communication, which affects a direct communication service of the user devices.

### SUMMARY

Embodiments of the present disclosure provide a resource allocation method and device for direct communication between user devices, so as to ensure a normal direct communication service of user devices when a resource for direct communication changes.

According to a first aspect, an embodiment of the present disclosure provides a resource allocation method for direct communication between user devices, including determining, by a third device, a first resource, where the first resource includes some or all of a second resource, the second resource is determined by the third device before the first resource is determined, and the first resource and the second resource are both used for communication between a first user device and a second user device, and sending, by the third device, resource signaling to the first user device and/or the second user device, where the resource signaling carries information about the first resource.

According to a second aspect, an embodiment of the present disclosure provides a resource allocation method for direct communication between user devices, including receiving, by a first user device, resource signaling sent by a third device, where the resource signaling carries information about a first resource determined by the third device, the first resource includes some or all of a second resource, the second resource is determined by the third device before the first resource is determined, and the first resource and the second resource are both used for communication between the first user device and a second user device, and determining, by the first user device according to the information about the first resource, that the first resource is used for communication with the second user device.

According to a third aspect, an embodiment of the present disclosure provides a resource allocation method for direct communication between user devices, including receiving, by a first user device, first resource signaling sent by a third device, where the first resource signaling carries information about a first resource determined by the third device, and when determining that the first resource does not include some or all of a second resource, determining, by the first user device, that a resource used for communication with a second user device is the first resource and the second resource or is the second resource, where the second resource is determined by the third device before the first resource is determined, and the first resource and the second resource are both used for communication between the first user device and the second user device.

In a first possible implementation manner of the third aspect, when it is determined that a resource used for communication with the second user device is the first resource and the second resource, the method further includes starting, by the first user device, a preset timer, where the resource used for communication with the second user device within timing duration of the timer is the first resource and the second resource, and the resource used for communication with the second user device after the timing duration of the timer is the first resource.

With reference to the third aspect and the first possible implementation manner, in a second possible implementation manner, before the receiving, by a first user device, first resource signaling sent by a third device, the method further includes receiving, by the first user device, second resource signaling sent by the third device, where the second resource signaling carries information about the second resource.

According to a fourth aspect, an embodiment of the present disclosure provides a resource allocation device for user communication, including a processing module configured to determine a first resource, where the first resource includes some or all of a second resource, the second resource is determined by the processing module before the first resource is determined, and the first resource and the second resource are both used for communication between a first user device and a second user device, and a sending module configured to send resource signaling to the first user device and/or the second user device, where the resource signaling carries information about the first resource.

According to a fifth aspect, an embodiment of the present disclosure provides a user device, where the user device includes a receiving module configured to receive resource signaling sent by a third device, where the resource signaling carries information about a first resource determined by the third device, the first resource includes some or all of a second resource, the second resource is determined by the third device before the first resource is determined, and the first resource and the second resource are both used for communication between the user device and a second user device, and a processing module configured to determine, according to the information about the first resource, that the first resource is used for communication with the second user device.

According to a sixth aspect, an embodiment of the present disclosure provides a user device, where the user device includes a receiving module configured to receive first resource signaling sent by a third device, where the first resource signaling carries information about a first resource determined by the third device, and a processing module configured to when determining that the first resource does not include some or all of a second resource, determine that a resource used for communication with a second user device is the first resource and the second resource or is the second resource, where the second resource is determined by the third device before the first resource is determined, and the first resource and the second resource are both used for communication between the user device and the second user device.

In a first possible implementation manner of the sixth aspect, the processing module is further configured to: when determining that a resource used for communication with the second user device is the first resource and the second resource, start a preset timer, where the resource used for communication with the second user device within timing duration of the timer is the first resource and the second resource, and the resource used for communication with the second user device after the timing duration of the timer is the first resource.

With reference to the sixth aspect and the first possible implementation manner, in a second possible implementation manner, the receiving module is further configured to: receive second resource signaling sent by the third device, where the second resource signaling carries information about the second resource allocated by the third device for communication between the user device and the second user device.

The embodiments of the present disclosure provide a resource allocation method and device for direct communication between user devices, which ensure a normal direct communication service of the user devices when a resource for direct communication changes.

### BRIEF DESCRIPTION OF DRAWINGS

To describe the technical solutions in the embodiments of the present disclosure more clearly, the following briefly introduces the accompanying drawings required for describing the embodiments. The accompanying drawings in the following description show some embodiments of the present disclosure, and a person of ordinary skill in the art may still derive other drawings from these accompanying drawings without creative efforts.

FIG. 1 is a flowchart of an embodiment of a resource allocation method for direct communication between user devices provided by the present disclosure.

FIG. 2 is a flowchart of another embodiment of a resource allocation method for direct communication between user devices provided by the present disclosure.

FIG. 3 is a flowchart of still another embodiment of a resource allocation method for direct communication between user devices provided by the present disclosure.

FIG. 4 is a schematic structural diagram of an embodiment of a resource allocation device for direct communication between user devices provided by the present disclosure.

FIG. 5 is a schematic structural diagram of another embodiment of a resource allocation device for user communication provided by the present disclosure.

FIG. 6 is a schematic structural diagram of an embodiment of a user device provided by the present disclosure.

FIG. 7 is a schematic structural diagram of another embodiment of a user device provided by the present disclosure.

FIG. 8 is a schematic structural diagram of another embodiment of a user device provided by the present disclosure.

FIG. 9 is a schematic structural diagram of another embodiment of a user device provided by the present disclosure.

### DESCRIPTION OF EMBODIMENTS

To make the objectives, technical solutions, and advantages of the embodiments of the present disclosure clearer, the following clearly describes the technical solutions in the embodiments of the present disclosure with reference to the accompanying drawings in the embodiments of the present disclosure. The described embodiments are some but not all of the embodiments of the present disclosure. All other embodiments obtained by a person of ordinary skill in the art based on the embodiments of the present disclosure without creative efforts shall fall within the protection scope of the present disclosure.

Technologies described in this specification may be applied to various communications systems, for example, current second generation (2G) and third generation (3G) communications systems and a next-generation communications system, for example, a Global System for Mobile Communications (GSM), a Code Division Multiple Access (CDMA) system, a Time Division Multiple Access (TDMA) system, a Wideband Code Division Multiple Access (WCDMA) system, a Frequency Division Multiple Access (FDMA) system, an Orthogonal Frequency-Division Multiple Access (OFDMA) system, a single-carrier FDMA (SC-FDMA) system, a General Packet Radio Service (GPRS) system, a LTE system, and other communications systems.

A terminal in this application, that is, user equipment, may be a wireless terminal or a wired terminal. The wireless terminal may refer to a device that provides a user with voice and/or data connectivity, a handheld device with a radio connection function, or another processing device connected to a radio modem. The wireless terminal may communicate with one or more core networks through a radio access network (RAN). The wireless terminal may be a mobile terminal, such as a mobile phone (also referred to as a “cellular” phone) and a computer with a mobile terminal, for example, may be a portable, pocket-sized, handheld, computer built-in, or in-vehicle mobile apparatus, which exchanges voice and/or data with the radio access network. For example, it may be a device such as a personal communication service (PCS) phone, a cordless telephone set, a Session Initiation Protocol (SIP) phone, a wireless local loop (WLL) station, or a personal digital assistant (PDA). The wireless terminal may also be called a system, a subscriber unit, a subscriber station, a mobile station, a mobile terminal (Mobile), a remote station, an access point, a remote terminal, an access terminal, a user terminal, a user agent, a user device, or a user equipment.

A base station (for example, an access point) involved in this application may refer to a device on the access network that communicates with the wireless terminal on an air interface by using one or more sectors. The base station may be configured to mutually convert a received over-the-air frame and an IP packet and serve as a router between the wireless terminal and a rest portion of the access network, where the rest portion of the access network may include an Internet protocol (IP) network. The base station may also coordinate attribute management of the air interface. For example, the base station may be a base transceiver station (BTS) in GSM or the CDMA, may also be a base station (NodeB) in WCDMA, and may further be an evolved NodeB (NodeB, eNB, or e-NodeB, evolved Node B) in the LTE, which is not limited in the present application.

In addition, the terms “system” and “network” may be used interchangeably in this specification. The term “and/or” in this specification describes only an association relationship for describing associated objects and represents that three relationships may exist. For example, A and/or B may represent the following three cases: Only A exists, both A and B exist, and only B exists. In addition, the character “/” in this specification generally indicates an “or” relationship between the associated objects.

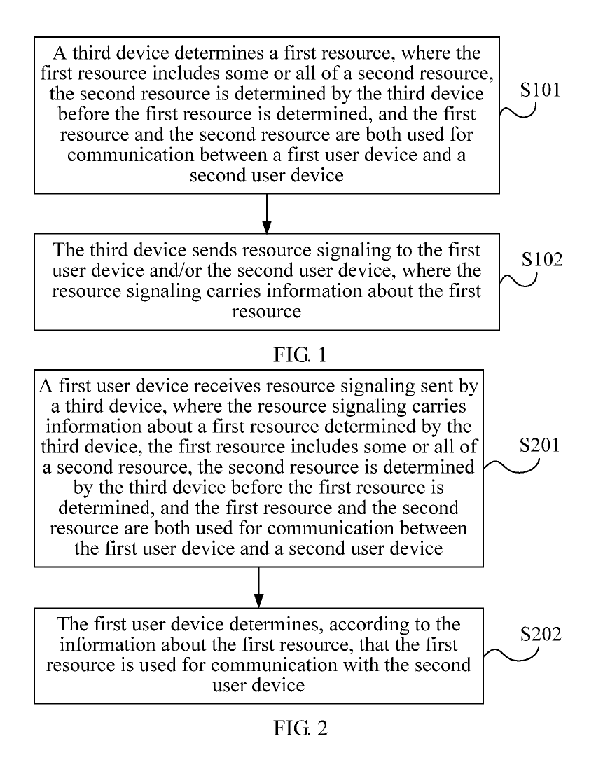

FIG. 1 is a flowchart of an embodiment of a resource allocation method for direct communication between user devices provided by the present disclosure. As shown in FIG. 1, the method includes S101: A third device determines a first resource, where the first resource includes some or all of a second resource, the second resource is determined by the third device before the first resource is determined, and the first resource and the second resource are both used for communication between a first user device and a second user device.

S102: The third device sends resource signaling to the first user device and/or the second user device, where the resource signaling carries information about the first resource.

The foregoing steps are performed by the third device, where the third device may be a base station, may be a user device, or may be a device of another type except the first user device and the second user device.

The method provided in this embodiment is applicable to an implementation scenario of direct communication between the first user device and the second user device. The first resource is a resource currently allocated by the third device for communication between the first user device and the second user device, and the second resource is a resource allocated by the third device for communication between the first user device and the second user device before the first resource is allocated. The information about the first resource may be frequency domain information and/or time domain information and the like of the first resource; and similarly, the information about the second resource may also be frequency domain information and/or time domain information and the like of the second resource.

The first resource may include some or all of the second resource. The following provides description by using an example in which the first resource includes some of the second resource: The second resource that is allocated by the third device for communication between the first user device and the second user device before the first resource is allocated (that is, the second resource allocated last time prior to the first resource that is currently allocated) includes a resource A and a resource B. The first user device and the second user device that participate in direct communication both learn channel state information of the resource A and the resource B, and the first user device and the second user device perform direct communication on the resource A and the resource B; therefore, direct communication can be performed on the resource A and the resource B. When the third device schedules a new resource, the first resource allocated by the third device for communication between the first user device and the second user device includes the resource B and a resource C. The resource B is not only included in the second resource that is allocated by the third device before the first resource is allocated, but also included in the first resource that is currently allocated by the third device. Therefore, for the new resource C, the first user device and the second user device need to perform channel sounding for a period of time to obtain channel state information. However, during this period of time, the first user device and the second user device can continue to perform direct communication by using the resource B, to ensure that communication proceeds normally without interruption.

The third device may send the resource signaling to either or both of the first user device and the second user device. However, it should be noted that, in the implementation scenario in this embodiment, if the first resource currently allocated by the third device does not include any resource in the second resource, after the first user device and/or the second user device receives the resource signaling, it may be considered that the first resource currently allocated by the third device is an erroneous configuration. The direct communication can still be performed between the first user device and the second user device by using the second resource that is allocated by the third device before the first resource is allocated.

This embodiment provides a resource allocation method for direct communication between user devices, where a first resource allocated by a third device for communication between a first user device and a second user device includes some or all of a second resource that is allocated by the third device before the first resource is allocated, so that when a resource for direct communication changes, a normal direct communication service between the user devices is ensured.

FIG. 2 is a flowchart of another embodiment of a resource allocation method for direct communication between user devices provided by the present disclosure. As shown in FIG. 2, the method includes S201: A first user device receives resource signaling sent by a third device, where the resource signaling carries information about a first resource determined by the third device, the first resource includes some or all of a second resource, the second resource is determined by the third device before the first resource is determined, and the first resource and the second resource are both used for communication between the first user device and a second user device.

S202: The first user device determines, according to the information about the first resource, that the first resource is used for communication with the second user device.

It should be noted that, the first user device that performs the foregoing steps in this embodiment may be either user device in two user devices that perform direct communication, that is, the two user devices that perform direct communication both can receive the resource signaling sent by the third device.

For S201 and S202, reference may be made to relevant descriptions in S101 and S102. It should be noted that, if the first resource that is carried in the resource signaling received by the first user device includes some or all of the second resource, where the second resource is allocated by the third device for communication between the first user device and the second user device before the first resource is allocated, the first user device may use the first resource according to the information about the first resource. The following is included: During a period of time in which the first user device and the second user device perform channel sounding to obtain channel state information of a new resource (which refers to another resource in the first resource except the included second resource), direct communication is performed by using the second resource included in the first resource, to ensure that the communication proceeds normally without interruption. After the channel state information of the new resource is obtained through channel sounding, direct communication is performed by using the first resource.

This embodiment provides a resource allocation method for direct communication between user devices, where a first resource that is received by the first user device and allocated by a third device for communication between a first user device and a second user device includes some or all of a second resource that is allocated by the third device before the first resource is allocated, so that when a resource for direct communication changes, a normal direct communication service between the user devices is ensured.

FIG. 3 is a flowchart of still another embodiment of a resource allocation method for direct communication between user devices provided by the present disclosure. As shown in FIG. 3, the method includes S301: A first user device receives first resource signaling sent by a third device, where the first resource signaling carries information about a first resource determined by the third device.

S302: When determining that the first resource does not include some or all of a second resource, the first user device determines that a resource used for communication with a second user device is the first resource and the second resource or is the second resource, where the second resource is determined by the third device before the first resource is determined, and the first resource and the second resource are both used for communication between the first user device and the second user device.

It should be noted that, the first user device that performs the foregoing steps in this embodiment may be either user device in two user devices that perform direct communication, that is, the two user devices that perform direct communication both can receive the resource signaling sent by the third device.

Similar to the first resource signaling, before receiving the first resource signaling, the first user device receives second resource signaling sent by the third device, where the second resource signaling carries information about the second resource allocated by the third device for communication between the first user device and the second user device.

When the third device schedules a new resource for the first user device, the first user device receives the first resource signaling sent by the third device, where the first resource signaling carries the information about the first resource allocated by the third device for communication between the first user device and the second user device.

If the first resource currently allocated by the third device does not include some or all of the second resource allocated by the third device for communication between the first user device and the second user device before the first resource is allocated, for example, the second resources previously allocated by the third device are a resource A and a resource B, and the currently allocated first resources are a resource C and a resource D. In this implementation scenario, as a feasible implementation manner, the third device and the user device that receives the first resource signaling in direct communication determine that a resource used for communication with the second user device is the first resource and the second resource or is the second resource.

Optionally, when determining that the to-be-used resources are the first resource and the second resource, the first user device may further start a preset timer (timer), where resources used for communication between the first user device and the second user device within timing duration are the first resource and the second resource, and the second resource is not used after the timing duration elapses. That is, the resource allocated before the first resource is allocated is valid only within a period of time. For example, the resource A and the resource B that are scheduled before the first resource is allocated are valid only within a period of time, and after the timing duration of the timer elapses, only the resource C and the resource D are used for direct communication between the first user device and the second user device. It should be noted that, the timing duration of the timer generally needs to be greater than a time length used by the first user device and the second user device to obtain, through channel sounding, channel state information of a new resource (the resource C and the resource D). After the timing duration of the timer elapses, the resource used for communication with the second user device is the first resource.

If the first resource currently allocated by the third device does not include some or all of the second resource allocated by the third device for communication between the first user device and the second user device before the first resource is allocated, in another feasible implementation manner, the first user device determines that a resource used in direct communication with the second user device is the second resource. In this implementation scenario, the third device and the user device that receives the first resource signaling in direct communication determine that direct communication is performed by still using the second resource that is allocated by the third device before the first resource is allocated.

This embodiment provides a resource allocation method for direct communication between user devices. If a first resource currently allocated by a third device does not include some or all of a second resource that is allocated by the third device before the first resource is allocated, it is determined that a resource used for communication with a second user device is the first resource and the second resource or is the second resource, so that when a resource for direct communication changes, a normal direct communication service between the user devices is ensured.

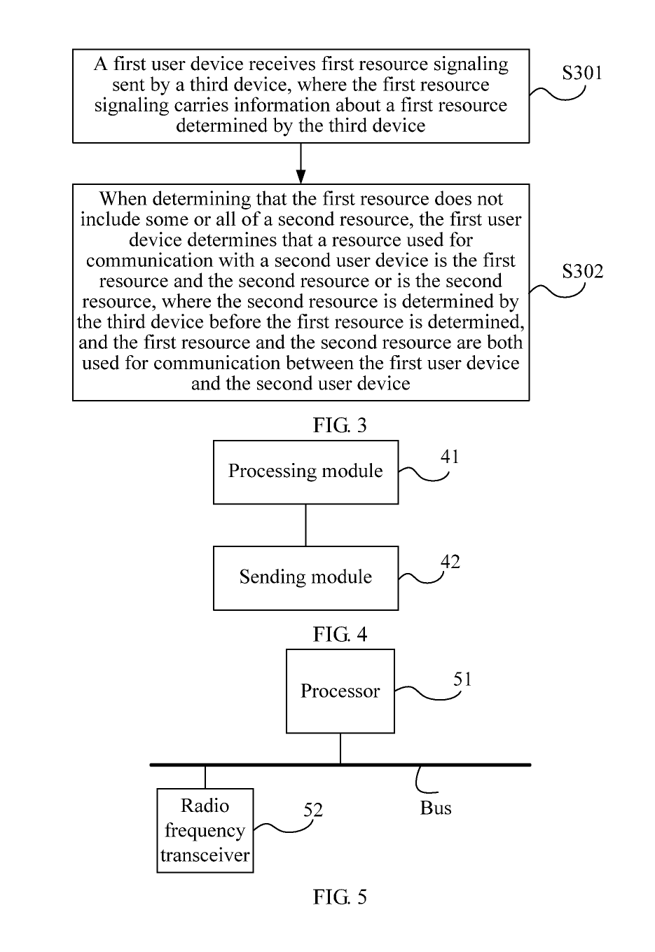

FIG. 4 is a schematic structural diagram of an embodiment of a resource allocation device for direct communication between user devices provided by the present disclosure. As shown in FIG. 4, the device may be a base station, or may be a user device, and includes a processing module 41 configured to determine a first resource, where the first resource includes some or all of a second resource, the second resource is determined by the processing module before the first resource is determined, and the first resource and the second resource are both used for communication between a first user device and a second user device, and a sending module 42 configured to send resource signaling to the first user device and/or the second user device, where the resource signaling carries information about the first resource.

This embodiment of the present disclosure provides a resource allocation device for direct communication between user devices. A first resource allocated for communication between a first user device and a second user device includes some or all of a second resource that is allocated by the third device before the first resource is allocated, so that when a resource for direct communication changes, a normal direct communication service between the user devices is ensured.

FIG. 5 is a schematic structural diagram of another embodiment of a resource allocation device for direct communication between user devices provided by the present disclosure. As shown in FIG. 5, the device may be a base station, or may be a user device, and includes: a processor 51 and a radio frequency transceiver 52, where the processor 51 and the radio frequency transceiver 52 are coupled by using a bus, where the processor 51 is configured to: determine a first resource, where the first resource includes some or all of a second resource, the second resource is determined by the processor 51 before the first resource is determined, and the first resource and the second resource are both used for communication between a first user device and a second user device, and the radio frequency transceiver 52 is configured to: send resource signaling to the first user device and/or the second user device, where the resource signaling carries information about the first resource.

This embodiment of the present disclosure provides a resource allocation device for direct communication between user devices, where a first resource allocated for communication between a first user device and a second user device includes some or all of a second resource that is allocated by the third device before the first resource is allocated, so that when a resource for direct communication changes, a normal direct communication service between the user devices is ensured.

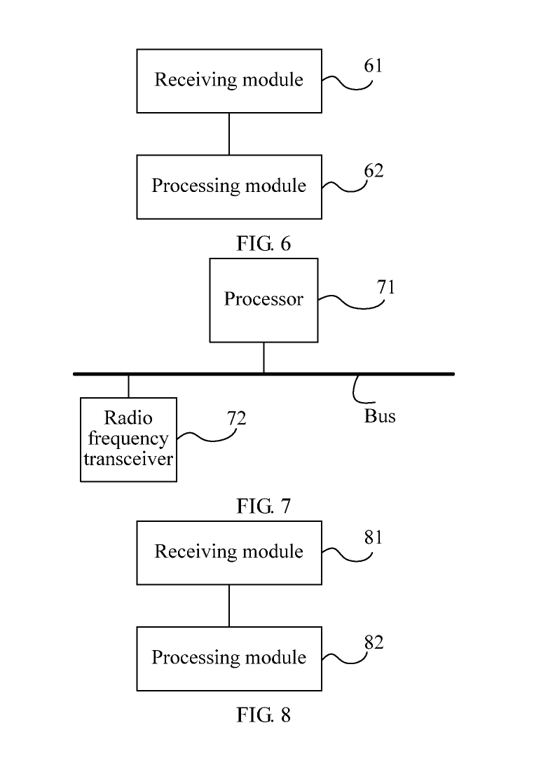

FIG. 6 is a schematic structural diagram of an embodiment of a user device provided by the present disclosure. As shown in FIG. 6, the user device is a first user device, and includes a receiving module 61 configured to receive resource signaling sent by a third device, where the resource signaling carries information about a first resource determined by the third device, the first resource includes some or all of a second resource, the second resource is determined by the third device before the first resource is determined, and the first resource and the second resource are both used for communication between the first user device and a second user device, and a processing module 62 configured to determine, according to the information about the first resource, that the first resource is used for communication with the second user device.

This embodiment of the present disclosure provides a user device, where a first resource that is received from a third device and allocated for communication between a first user device and a second user device includes some or all of a second resource that is allocated by the third device before the first resource is allocated, so that when a resource for direct communication changes, a normal direct communication service between the user devices is ensured.

FIG. 7 is a schematic structural diagram of another embodiment of a user device provided by the present disclosure. As shown in FIG. 7, the user device is a first user device, and includes: a processor 71 and a radio frequency transceiver 72, where the processor 71 and the radio frequency transceiver 72 are coupled by using a bus, where the radio frequency transceiver 72 is configured to receive resource signaling sent by a third device, where the resource signaling carries information about a first resource determined by the third device, the first resource includes some or all of a second resource, the second resource is determined by the third device before the first resource is determined, and the first resource and the second resource are both used for communication between the first user device and a second user device, and the processor 71 is configured to determine, according to the information about the first resource, that the first resource is used for communication with the second user device.

This embodiment of the present disclosure provides a user device, where a first resource that is received from a third device and allocated for communication between the first user device and a second user device includes some or all of a second resource that is allocated by the third device before the first resource is allocated, so that when a resource for direct communication changes, a normal direct communication service between the user devices is ensured.

FIG. 8 is a schematic structural diagram of another embodiment of a user device provided by the present disclosure. The user device is a first user device, and includes a receiving module 81 configured to receive first resource signaling sent by a third device, where the first resource signaling carries information about a first resource determined by the third device, and a processing module 82 configured to configured to when determining that the first resource does not include some or all of a second resource, determine that a resource used for communication with a second user device is the first resource and the second resource or is the second resource, where the second resource is determined by the third device before the first resource is determined, and the first resource and the second resource are both used for communication between the first user device and the second user device.

The processing module 82 may be further configured to: when determining that a resource used for communication with the second user device is the first resource and the second resource, start a preset timer, where the resource used for communication with the second user device within timing duration of the timer is the first resource and the second resource, and the resource used for communication with the second user device after the timing duration of the timer is the first resource.

Optionally, the receiving module 81 may be further configured to: receive second resource signaling sent by the third device, where the second resource signaling carries information about the second resource allocated by the third device for communication between the first user device and the second user device.

According to the user device provided in this embodiment, if a first resource allocated by a third device does not include some or all of a second resource that is allocated by the third device before the first resource is allocated, the user device determines that a resource used for communication with a second user device is the first resource and the second resource or is the second resource, so that when a resource for direct communication changes, a normal direct communication services between the user devices is ensured.

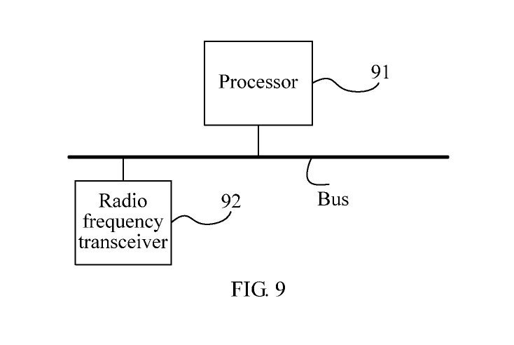

FIG. 9 is a schematic structural diagram of another embodiment of a user device provided by the present disclosure. The user device is a first user device, and includes: a processor 91 and a radio frequency transceiver 92, where the processor 91 and the radio frequency transceiver 92 are coupled by using a bus, where the radio frequency transceiver 92 is configured to receive first resource signaling sent by a third device, where the first resource signaling carries information about a first resource determined by the third device, and the processor 91 is configured to: when determining that the first resource does not include some or all of a second resource, determine that a resource used for communication with a second user device is the first resource and the second resource or is the second resource, where the second resource is determined by the third device before the first resource is determined, and the first resource and the second resource are both used for communication between the first user device and the second user device.

Optionally, the processor 91 may be further configured to: when determining that a resource used for communication with the second user device is the first resource and the second resource, start a preset timer, where the resource used for communication with the second user device within timing duration of the timer is the first resource and the second resource, and the resource used for communication with the second user device after the timing duration of the timer is the first resource.

Optionally, the radio frequency transceiver 92 may be further configured to: receive second resource signaling sent by the third device, where the second resource signaling carries information about the second resource allocated by the third device for communication between the first user device and the second user device.

According to the user device provided in this embodiment, if a first resource allocated by a third device does not include some or all of a second resource that is allocated by the third device before the first resource is allocated, the user device determines that a resource used for communication with a second user device is the first resource and the second resource or is the second resource, so that when a resource for direct communication changes, a normal direct communication services between the user devices is ensured.

It may be clearly understood by a person skilled in the art that, for the purpose of convenient and brief description, division of the foregoing functional modules is taken as an example for illustration. In actual application, the foregoing functions can be allocated to different functional modules and implemented according to a requirement, that is, an inner structure of an apparatus is divided into different functional modules to implement all or some of the functions described above. For a detailed working process of the foregoing system, apparatus, and unit, reference may be made to a corresponding process in the foregoing method embodiments, and details are not described herein again.

In the several embodiments provided in the present application, it should be understood that the disclosed system, apparatus, and method may be implemented in other manners. For example, the described apparatus embodiment is merely exemplary. For example, the module or unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present application may be integrated into one processing unit, or each of the units may exist alone physically, or two or more units are integrated into one unit. The integrated unit may be implemented in a form of hardware, or may be implemented in a form of a software functional unit.

When the integrated unit is implemented in the form of a software functional unit and sold or used as an independent product, the integrated unit may be stored in a computer-readable storage medium. Based on such an understanding, the technical solutions of the present application essentially or all or some of the technical solutions may be implemented in the form of a software product. The software product is stored in a storage medium and includes several instructions for instructing a computer device (which may be a personal computer, a server, or a network device) or a processor to perform all or some of the steps of the methods in the embodiments of the present application. The foregoing storage medium includes: any medium that can store program code, such as a USB flash drive, a removable hard disk, a read-only memory (ROM), a random access memory (RAM), a magnetic disk, or an optical disc.

The foregoing embodiments are merely intended for describing the technical solutions of the present application, but not for limiting the present application. Although the present application is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present application.

An embodiment of the present disclosure provides a resource allocation method for direct communication between user devices, comprising: determining, by a third device, a first resource, wherein the first resource comprises some or all of a second resource, the second resource is determined by the third device before the first resource is determined, and the first resource and the second resource are both used for communication between a first user device and a second user device; and sending, by the third device, resource signaling to the first user device and/or the second user device, wherein the resource signaling carries information about the first resource.

An embodiment of the present disclosure provides a resource allocation device for direct communication between user devices, comprising: a processing module configured to determine a first resource, wherein the first resource comprises some or all of a second resource, the second resource is determined by the processing module before the first resource is determined, and the first resource and the second resource are both used for communication between a first user device and a second user device; and a sending module configured to send resource signaling to the first user device and/or the second user device, wherein the resource signaling carries information about the first resource.

An embodiment of the present disclosure provides a user device, wherein the user device comprises: a receiving module configured to receive resource signaling sent by a third device, wherein the resource signaling carries information about a first resource determined by the third device, the first resource comprises some or all of a second resource, the second resource is determined by the third device before the first resource is determined, and the first resource and the second resource are both used for communication between the user device and a second user device; and a processing module configured to determine, according to the information about the first resource, that the first resource is used for communication with the second user device.

What is claimed is:

1. A resource allocation method for direct communication between user devices, comprising:
receiving, by a first user device, first resource signaling from a third device, wherein the first resource signaling carries information about a first resource determined by the third device; and
determining, by the first user device, that a resource used for communication with a second user device is a second resource when determining that the first resource does not comprise at least a portion of the second resource, wherein the second resource is determined by the third device before the first resource is determined, and wherein the first resource and the second resource are both used for communication between the first user device and the second user device.

2. The method according to claim 1, further comprising determining, by the first user device, that the resource used for communication with the second user device is the first resource and the second resource when determining that the first resource does not comprise at least the portion of the second resource.

3. The method according to claim 1, wherein when it is determined that the resource used for communication with the second user device is the first resource and the second resource, the method further comprises starting, by the first user device, a preset timer, wherein the resource used for communication with the second user device within a timing duration of the preset timer is the first resource and the second resource, and wherein the resource used for communication with the second user device after the timing duration of the preset timer is the first resource.

4. The method according to claim 1, wherein before receiving, by the first user device, the first resource signaling from a third device, the method further comprises receiving, by the first user device, a second resource signaling from the third device, wherein the second resource signaling carries information about the second resource.

5. A resource allocation method for direct communication between user devices,
comprising:
receiving, by a first user device, a resource signaling from a third device, wherein the resource signaling carries information about a first resource determined by the third device, wherein the first resource comprises at least a portion of a second resource, wherein the second resource is determined by the third device before the first resource is determined, and wherein the first resource and the second resource are both used for communication between the first user device and a second user device; and
determining, by the first user device according to the information about the first resource, that the first resource is used for communication with the second user device.

6. A user device, wherein the user device comprises:
a receiving module configured to receive a first resource signaling from a third device, wherein the first resource signaling carries information about a first resource determined by the third device; and
a processing module configured to determine that a resource used for communication with a second user device is a second resource when determining that the first resource does not comprise at least a portion of the second resource, wherein the second resource is determined by the third device before the first resource is determined, and wherein the first resource and the second resource are both used for communication between the user device and the second user device.

7. The user device according to claim 6, wherein the processing module is further configured to determine that the resource used for communication with the second user device is the first resource and the second resource when determining that the first resource does not comprise at least the portion of the second resource.

8. The user device according to claim 7, wherein the processing module is further configured to start a preset timer when determining that the resource used for communication with the second user device is the first resource and the second resource, wherein the resource used for communication with the second user device within a timing duration of the preset timer is the first resource and the second resource, and wherein the resource used for communication with the second user device after the timing duration of the preset timer is the first resource.

9. The user device according to claim 6, wherein the receiving module is further configured to receive a second resource signaling from the third device, wherein the second resource signaling carries information about the second resource allocated by the third device for communication between the user device and the second user device.
